(19) United States
(12) Patent Application Publication
(10) Pub. No.: US 2015/0070659 A1
(43) Pub. Date: Mar. 12, 2015

(54) METHOD FOR REDUCING SPECKLES AND A LIGHT SOURCE USED IN SAID METHOD

(71) Applicant: Lemoptix SA, Lausanne (CH)

(72) Inventors: Xuyuan Chen, Borre (NO); Zhaomin Tong, Jiangsu Province (CN); Muhammad Nadeem Akram, Borre (NO)

(73) Assignee: Lemoptix SA, Lausanne (CH)

(21) Appl. No.: 14/022,954

(22) Filed: Sep. 10, 2013

(51) Int. Cl. G02B 27/48

(52) U.S. Cl. CPC G02B 27/48
USPC 353/38; 353/121

(57) ABSTRACT

A method of reducing speckle effects in a projected image which is displayed on a display surface, comprising the steps of splitting an incident beam into one reference beam and one modulation beam; modulating said modulation beam with a modulation unit so as to produce a modulated beam; recombining the modulated beam and the reference beam onto a diffuser; and deflecting the recombined beam so as to project said image onto said display surface.

### FIELD OF THE INVENTION

The present invention concerns a method for reducing speckle, and in particular but not exclusively a method for reducing speckle in a projection system by introducing temporally changing interference fringes by means of using a light modulating mean.

### DESCRIPTION OF RELATED ART

A speckle pattern is an intensity pattern produced by the mutual interference of a set of wavefronts. In image projection systems which use lasers, speckle patterns are caused by coherent light interferences which occur on rough display surfaces. Speckle reduces the quality of a projected image as each pixel of a projected image will have a non-uniform intensity; for each pixel of the projected image certain areas of the pixel will appear brighter than other areas of the pixel. The non-uniform intensity of a pixel caused by speckle patterns is referred to in the art as “speckle effects”.

In order to reduce the effect of speckle in projection systems, it is known to generate multiple speckle patterns for each pixel and/or each image frame; the multiple speckle patterns are arranged to partially overlay each other and the variation in the brightness across the pixel is reduced as a result. The more speckle patterns which are generated for each pixel and/or each image frame, the greater the reduction in the variation in the brightness across the pixel and/or an image frame which can be achieved.

One of the difficulties which this solution is that to achieve a reduction in the variation in the brightness across the pixel and/or an image frame the multiple speckle patterns must not fully overlay each other (the multiple speckle patterns must each partially overlay each other); while at the same time each of the multiple speckle pattern must be projected within a predefined area of the pixel and/or an image frame, otherwise the pixel and/or an image will appear blurred. It is difficult to ensure that each of the multiple pixel patterns are both projected within the predefined area of the pixel and/or an image frame and also do not fully overlay each other.

It is an aim of the present invention to obviate or mitigate at least some of the above-mentioned disadvantages.

### BRIEF SUMMARY OF THE INVENTION

According to one aspect of the invention, the effect of speckle in projection systems is reduced by using interference fringes. Interference fringes are light and dark bands produced by the interference and diffraction of light.

According to one aspect, speckle effects in a projected image which is displayed on a display surface are reduced by voluntarily producing interference fringes on the display surface so as to reduce the speckles' contrast.

The method preferably comprises the steps of: splitting an incident beam into one reference beam and one modulation beam; modulating said modulation beam with a modulation unit so as to produce a modulated beam; recombining the modulated beam and the reference beam onto a diffuser; and deflecting the recombined beam so as to project said image onto said display surface.

The coherent light beam may be produced by a coherent light source. The method could comprise a step of shaping (collimating, focusing and/or changing divergence angle(s)) said coherent light beam with a lens so as to produce said incident beam light.

The method could comprise a step of condensing said modulated beam with a condenser lens. Therefore, light rays deviated in different directions by the modulation unit are condensed onto a single point so as to increase the contrast between interference fringes.

The diffuser could comprise a passive diffuser, such as for example a standard optical diffuser. In one embodiment, the diffuser is a diffuser similar to the ones used in head-up display application in order to create an eyebox so that the user seen the totality of the image even whole moving his viewing point

The diffuser could comprise an active diffuser, i.e. a diffuser comprising moving parts. The diffuser could be part of the deflecting device. The diffuser could comprise one or several parts.

The modulated beam and the reference beam might be recombined at the diffuser.

The modulated beam and the reference beam might be recombined before the diffuser, and result into a recombined light beam that is recombined when reaching the diffuser.

The recombined beam might be deflected with a mems-based digital micromirror device.

The recombined beam might be deflected with one two-dimensional mems scanning mirror and/or with two independent one-dimensional scanning mirrors.

The recombined beam might be deflected with a liquid crystal based device.

The modulation might be performed with a rotative device, for example a rotative mirror that oscillates.

The modulation might be performed with a vibrating device.

The modulation might be performed with an electro-optical device.

The width of the interference fringes on the display surface is preferably comprised between 10⁻⁶ and 10⁻³ m so as to be not or barely perceptible by the human eye.

The incident beam might be a RGB beam source, such as a modulated RGB beam source where the intensity of each color is time-modulated so at to generate an incident beam where the intensity of each color component changes over time.

The method might comprise independent generation of interference fringes for each of the three color beams, and combining the independently modulated light beams after the modulation.

The incident beam might be time-modulated so as to vary the intensity of the recombined beam that is projected onto different portions of said display surface.

### BRIEF DESCRIPTION OF THE DRAWINGS

The invention will be better understood with the aid of the description of an embodiment given by way of example and illustrated by the figures, in which:

FIG. 1 is a block diagram of a light source according to a first embodiment, including a measure system.

FIG. 2 is a block diagram of a light source according to a second embodiment.

FIG. 3 is a block diagram of a light source according to a third embodiment.

FIG. 4 is a block diagram of a light source according to a fourth embodiment.

FIGS. 5A to 5C are block diagrams of various modulation unit that could be used in the various embodiments of the invention.

FIG. 6 is a block diagram of a light source according to the third embodiment and including a mems-based digital micromirror device as deflecting unit.

### DETAILED DESCRIPTION OF POSSIBLE EMBODIMENTS OF THE INVENTION

According to some aspects of the invention, the method includes splitting light into two beamlets and to recombine the beamlets at a display surface. When the beamlets are recombined, interference fringes are produced due to constructive and destructive interference between the beamlets. The interference fringes reduce speckle because independent speckle patterns are generated by each individual fringe within the resolution spot of the viewer. The resolution spot of the viewer is the smallest feature size that can be distinguished on the screen by the viewer at a specific distance. The multiple speckle patterns within the resolution spot do not overlap and are independent, thus they are averaged by the viewer's eye and the speckle contrast is reduced.

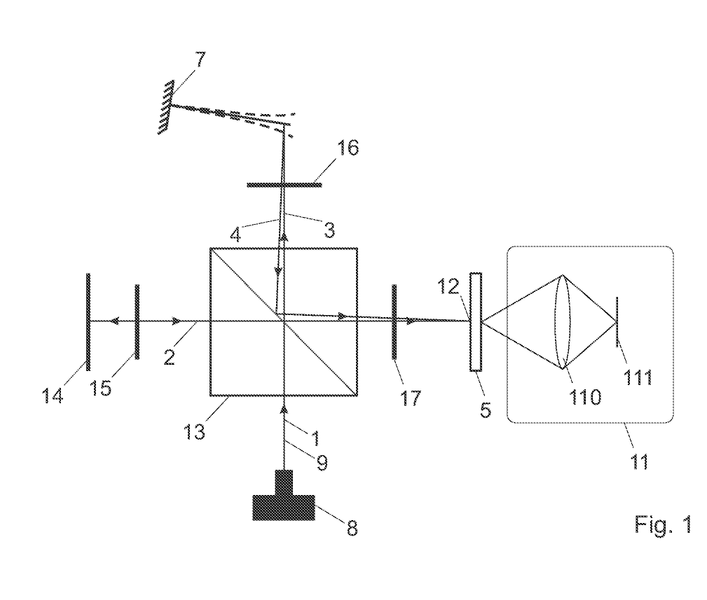

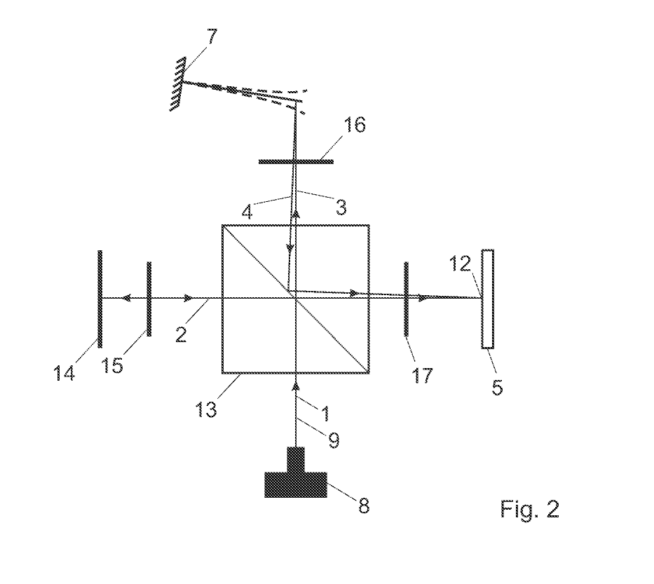

FIGS. 1 and 2 illustrate a first and second embodiment of a light source. The light source comprises a laser source 8, such a single wavelength wavesource or a RGB source producing a coherent light beam 9 (incident beam 1) in which several wavelengths, such as RGB wavelengths, are already combined. The incident light beam is splitted by a beam splitter 13 into a reference beam 2 and a modulation beam 3. The beam splitter has for example a 50/50 function (50% transmission/50% reflection).

The camera system 11 used for speckle measurement is composed of an image lens 110 and a CCD camera 111.

The reference beam is reflected by a mirror 14, such as stationary, highly flat surface mirror, and reached the diffuser 5 through the beam-splitter 13. A linear polarizer 15 may be placed in the path of the reference beam 2.

The modulation beam 3 is reflected by a modulation unit into a modulated beam 4 that reaches the diffuser 5 through the beam-splitter 13. A linear polarizer 15 may be placed in the path of the modulation beam 3 and/or of the modulated beam 4. The modulation unit can comprise a highly flat surface mirror that moves or oscillates.

The modulated beam and the reference beam are recombined onto the diffuser 5, creating interference fringes. A third linear polarizer 17 may be provided in the path of the light beam in front of the diffuser. A purpose of the third linear polarizer 17 is to maintain the polarization direction of the two beams which illuminate the diffuser 5.

The polarizers 15, 16 and 17 are placed in order to define the effects (separated or combined) of the reference beam 2 and/or the modulated beam 4 on the speckle reduction. They are usually not required in a projection system, and may be suppressed to increase the brightness.

The effect of the modulation unit 7 is to change the length of the path of the modulation and modulated beam, so as to move the interference fringes. Alternatively, or in addition, the modulation unit can change the direction of the modulated beam 4, also resulting into moving interference fringes. Thus, with the help of the vibration of modulation unit 7, diverse interference fringes and speckle patterns are added together in the intensity basis during the exposure time of a CCD camera 111 as part of a measure system 11. The reference 110 designates a collimating lens as part of the measure system.

This results in a summed speckle image having lower speckle contrast. Measures by the CCD camera of the measure system demonstrate a speckle reduction efficiency by this method. The obtained speckle contrast is 0.66 after recombining the modulation beam and the reference beam, which is lower than the 0.77 speckle contrast that would be reached by only using the modulation beam. Thus, the introduction of interference fringes helps the speckle reduction.

Comparing with other reduction approaches known in the art, introduction of the reference beam 2 enhances the speckle reduction efficiency. The extra degrees of speckle reduction are possibly obtained by the angular difference between the beams illumination angle.

The width or period of the interference fringes is preferably comparable with the speckle diameter, and possibly comparable with the lateral resolution of the camera lens 111 or human eye. Therefore, the speckles will be alternatively overlayed with black or bright fringes, reducing their contrast when integrated over a duration longer than the oscillating period. In one embodiment, the width of the interference fringes onto the display surface is comprised between 10−6 and 10−2 m so as to be not or barely perceptible by the human eye.

The modulation unit can comprise a moving reflecting surface, for example an oscillating reflecting surface 7. The oscillation frequency is preferably high enough so that the human eye (or the CCD camera) integrates the various positions of the interference fringes. In one preferred embodiment, the oscillation frequency of the modulation unit is such that the position of the fringes oscillate at an oscillating frequency higher than 25, preferably higher than 40.

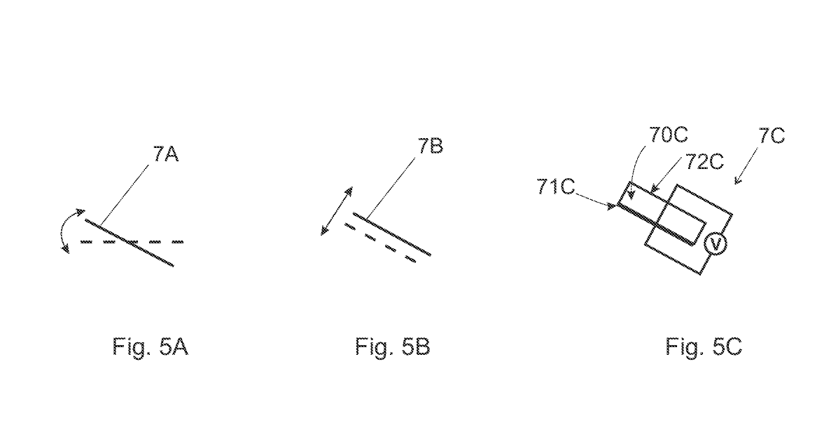

Examples of modulation units 7 are illustrated on FIGS. 5A to 5C. In the embodiment of FIG. 5A, the modulation unit comprises a rotating device 7A, such as a rotating mirror. The mirror can comprise several faces and rotate always in the same direction, or preferably one single flat face that oscillates around a rotation axis. This modulation unit changes the direction of the modulated beam. The mirror may be driven by a mems-based electromagnetic actuator.

In the embodiment of FIG. 5B, the modulation unit comprises a vibration device 7B, such as a vibrating mirror. The reflecting surface might be moved by a piezo-electric actuator or by a mems-based electromagnetic actuator.

In the embodiment of FIG. 5C, the modulation unit comprises an electro-optical actuator, such as for example an actuator based on an electro-active polymer 70C between a bottom electrode 71C and a top electrode 72C. An electric signal applied between the two electrodes causes a displacement of one electrode and of a reflecting mirror connected to this electrode.

The diffuser 5 could be a passive diffuser, such as for example a standard optical diffuser. In one embodiment, the diffuser is a diffuser similar to the ones used in head-up display application in order to create an eyebox so that the user seen the totality of the image even whole moving his viewing point.

The diffuser 5 could also be an active diffuser, i.e. a device where the diffusion of light is produced by a displacement of a component. In one embodiment, the diffuser is or comprises a moving mirror or a matrix of moving mirrors (DMD). The diffuser may comprise or be part of a projection system that projects the light onto a display surface. In one embodiment, the diffuser comprises or is part of a micromirror projecting system. In this case, the reference and modulated beam are recombined onto a component of a micromirror projecting system.

The diffuser 5 could also be a light diffusing mean like a Liquid crystal cell or matrix of liquid crystal cells (LCOS or LCD)

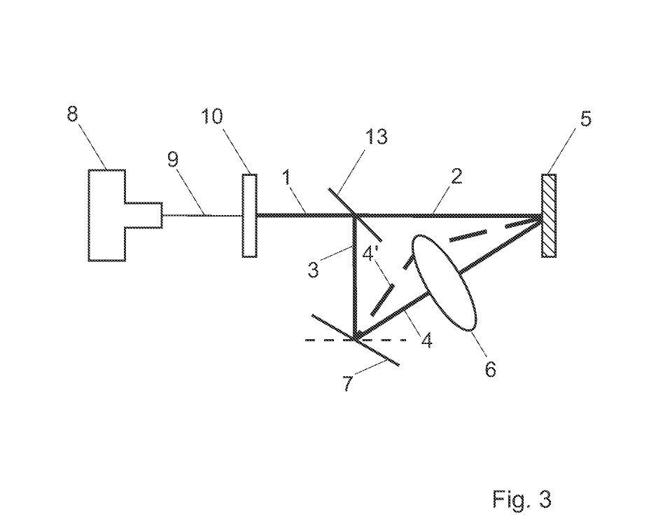

FIG. 3 illustrates another embodiment in which a condenser lens 6 is provided in the path of the modulated beam 4, in order to collimate the beams 4, 4′ that are deflected in various directions by the modulation unit onto a single common direction.

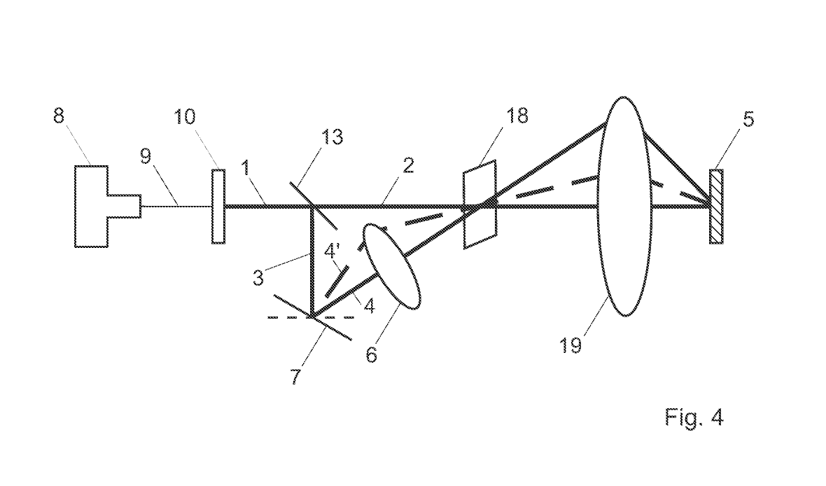

FIG. 4 illustrates another embodiment in which a relay lens is provided in order to reduce the width of the fringes produced onto the diffuser 5. The reference 100 is an intermediate image plane.

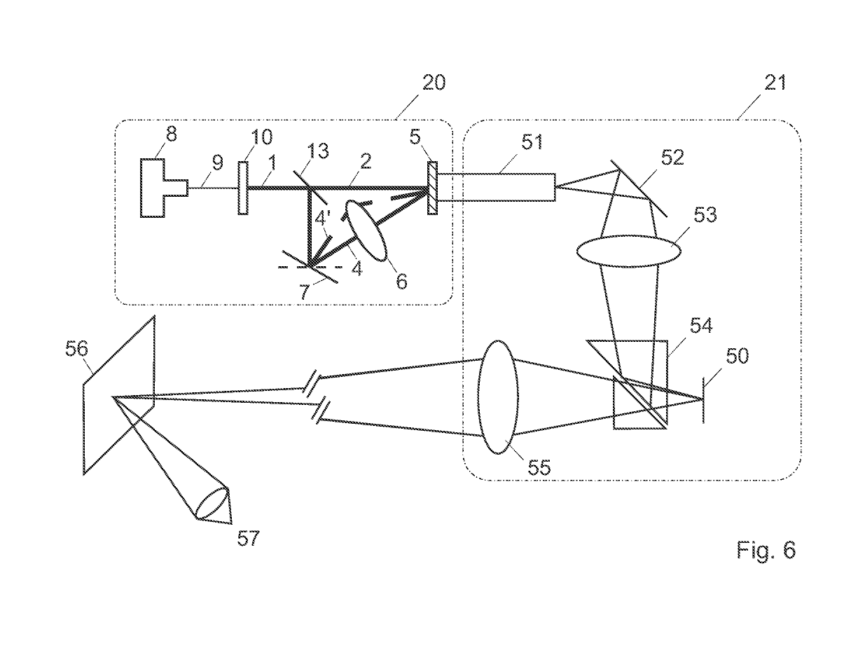

FIG. 6 illustrates another system that comprises a light source 20 similar to the one described in relation with FIG. 4, although other embodiments of light sources according to the invention could be used. The reference 21 designates a deflecting unit that deflects the light beam produced by the light source 20 so as to scan a display surface and to project a displayed image. The deflecting unit 21 may be a microprojector and may comprise a rod integrator 51, a mirror 52, a relay lens 53, a prism 54, a projection lens 55 and a deflecting mirror 50.

The deflecting mirror 50 may comprise a MEMS mirror. In one embodiment, the deflecting mirror 50 is a DMD—Digital Micromirror Device.

The deflecting mirror 50 configured to oscillate about an oscillation axis to scan the light beam in 1-dimension. It will be understood that the deflecting mirror 50 could alternatively be configured to oscillate about two orthogonal oscillation axis, to scan the input light beam in 2-dimensions. Two independent mirrors may be provided, each mirror scanning the light beam in 1 dimension. Optionally, the deflecting mirror 50 may have a curved profile.

In the figure, it is understood that the MEMS mirror 50 can be any type of reflective component, such as an array of digital micromirrors (DMD) or an array of Liquid Crystal On Silicon cells (LCOS) or a Liquid Crystal Display cells (LCD).

The reference beam 2 and the modulated beam 4 may be recombined for example onto the passive diffuser surface 5 at the output of the light source 20, and/or onto any surface of the deflecting unit 21, for example onto the deflecting mirror 50 acting as an active diffuser.

Alternatively, the diffuser may comprise or consist in a Liquid-crystal based display such as a LCD (Liquid Crystal Display) or a LCOS (Liquid Crystal On Silicon).

A system may comprise a single coherent light source 8, for example a source emitting at a single wavelength in the visible, infrared or ultraviolet range. Alternatively, the coherent light source 8 may comprise several light sources emitting at different wavelengths, such as R, G, B, so as to produce a color incident wavelength in which those wavelengths are combined. Alternatively, a system may comprise three light sources 20 according to one of the FIGS. 1 to 4, so as to generate three speckleless light beams at different wavelengths that might be input onto a light projector.

The intensity of light produced by the laser source or sources 8 might be modulated so as to change the intensity of light of each wavelength projected onto different portions of the projection surface.

The light source 20 may be built as a module. The deflecting unit 21 may be built as a module. Both components 20, 21 may be built as a single module, or as two independent modules that cooperate. Each module may comprise mechanical mounting parts, optical components, electronic components, and possibly MEMS components.

It will be understood that the methods and projection systems described above could be used in many different applications; for example optical coherence tomography, head up displays, head mounted displays, microlens arrays, laser projection systems for cinemas, rear projection displays, lithography, DMD or LCOS or GLV optical engines, laser illumination (microscopy, holography), and LIDAR.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

### REFERENCES

1 Incident beam
2 Reference beam
3 Modulation beam
4 Modulated beam
5 Diffuser
6 Condenser lens
7 Modulation unit
7A Rotation device as part of the modulation unit
7B Vibration device as part of the modulation unit
7C Electro-optic device as part of the modulation unit
8 Coherent light source, such as laser source
9 Coherent light beam
10 Beam shaper (lens)
11 Measure system
12 Recombined beam
110 Lens
111 CCD
13. Beam splitter
14. Mirror (stationary mirror)
15. Linear polarizer
16. Linear polarizer
17. Linear polarizer
18. Intermediate image plane
19. Relay lens
20. Light source
21. Deflecting unit
70C Electro-optic material
71C Bottom electrode
72C Top electrode
50 Digital micromirror device
51 Rod integrator
52 Mirror
53 Relay lens
54 Prism
55 Projection lens
56 Display surface (screen)
57 Detector (human eye or camera)

1. A method for reducing speckle effects in a projected image which is displayed on a display surface, comprising the steps of: splitting an incident beam into one reference beam and one modulation beam;
modulating said modulation beam with a modulation unit so as to produce a modulated beam;
recombining the modulated beam and the reference beam onto a diffuser;
deflecting the recombined beam so as to project said image onto said display surface.

2. The method of claim 1, further comprising:
producing a coherent light beam with a coherent light source;
collimating, focusing and/or changing divergence angle(s) of said coherent light beam with a lens so as to produce said incident beam light.

3. The method of claim 1, further comprising:
condensing said modulated beam with a condenser lens.

4. The method of claim 1, wherein said diffuser comprises a passive diffuser.

5. The method of claim 1, wherein said diffuser comprises an active diffuser.

6. The method of claim 1, said step of deflecting the recombined beam comprising deflecting said beam with a mems-based digital micromirrors device.

7. The method of claim 1, said step of deflecting the recombined beam comprising deflecting said beam with one two-dimensional mems scanning mirror or with two independent one-dimensional scanning mirrors.

8. The method of claim 1, said step of deflecting the recombined beam comprising deflecting said beam onto a liquid crystal based device.

9. The method of claim 1, said step of modulating comprising deflecting said modulating beam with a rotative device, for example a rotative mirror that oscillates.

10. The method of claim 1, said step of modulating comprising deflecting said modulating beam with a vibrating device.

11. The method of claim 1, said step of modulating comprising deflecting said modulating beam with an electro-optical device, such as for example an electro-active polymer.

12. The method of claim 1, wherein the width of said interference fringes on the display surface is comprised between 10⁻⁶ and 10⁻² m so as to be not or barely perceptible by the human eye.

13. The method of claim 1, wherein said incident beam is a RGB beam source.

14. The method of claim 1, independently applied to three said incident beams with different wavelengths.

15. The method of claim 1, comprising a step of time-modulating said incident beam so as to vary the intensity of the recombined beam that is projected onto different portions of said display surface.

16. A light source comprising:
a laser source for producing an incident beam a beam-splitter for splitting said incident beam into one reference beam and one modulation beam;
a modulation unit for modulating said modulation beam so as to produce a modulated beam;
a diffuser arranged so that the modulated beam and the reference beam are recombined onto said diffuser;
a deflecting unit for deflecting the recombined beam so as to project a speckle-free image onto a display surface.

17. The light source of claim 16, further comprising:
a beam shaper for collimating, focusing and/or changing divergence angle(s) the coherent beam generated by said laser source into said incident beam light.

18. The light source of claim 16, further comprising:
a condenser lens for condensing said modulated beam.

19. The light source of claim 16, said diffuser comprising a passive diffuser.

20. The light source of claim 16, said diffuser comprising an active diffuser.

21. The light source of claim 16, said deflecting unit comprising a mems-based digital micromirror device.

22. The light source of claim 16, said deflecting unit comprising one two-dimensional mems scanning mirror or two independent one-dimensional scanning mirrors.

23. The light source of claim 16, said deflecting unit comprising a liquid crystal based device.

24. The light source of claim 16, said modulation unit comprising a rotative device, for example an oscillating rotative mirror.

25. The light source of claim 16, said modulation unit comprising a vibrating device.

26. The light source of claim 16, said modulation unit comprising an electro-optical device.

27. The light source of claim 16, arranged for producing interference fringes on a display surface with a width comprised between 10⁻⁶ and 10⁻² m so as to be not or barely perceptible by the human eye.

28. The light source of claim 16, said laser source being a RGB beam source.

29. The light source of claim 16, said laser source being time-modulated so as to vary the intensity of the recombined beam.

30. A device comprising the light sources according to claim 17, each light source having a different wavelength.
